(19) United States
(12) Patent Application Publication
(10) Pub. No.: US 2012/0028712 A1
(43) Pub. Date: Feb. 2, 2012

(54) DISTRIBUTED CLOUD GAMING METHOD AND SYSTEM WHERE INTERACTIVITY AND RESOURCES ARE SECURELY SHARED AMONG MULTIPLE USERS AND NETWORKS

(75) Inventor: Patrick Zuili, Boca Raton, FL (US)

(73) Assignee: BRITESMART LLC, Boca Raton, FL (US)

(21) Appl. No.: 12/847,523

(22) Filed: Jul. 30, 2010

(51) Int. Cl. A63F 13/06; A63F 9/24

(52) U.S. Cl. 463/39; 463/42

(57) ABSTRACT

A method for rendering content from a first device to a second device in a network environment, comprising the steps of providing a Master set-top box, sending an invitation and a corresponding HDCP code from the Remote set-top box to the Master set-top box via a network interface, approving the invitation of the Remote set-top box and pairing the Master set-top box with available Remote set-top boxes, digitizing and compressing the content from the game console using the virtualization engine, splitting the compressed digital content into a plurality of network packets and sending to the Remote set-top box via a network interface, decompressing the received plurality of network packets, and sending them to atleast an audio/video output device.

### FIELD OF THE INVENTION

The present invention relates generally to networking and communication between devices, and more particularly, to a system and method for rendering content from a first device to a second device in a network environment.

### BACKGROUND OF THE INVENTION

In present times leisure activities have become a huge business and electronic video games are loved by members of all age. The technology associated with gaming has also evolved to give more realistic feel to games. Also the game controls have graduated from joystick to more advance 3D glasses, accelerometers, motion detectors etc which gives a player real feel of the game.

Game consoles output the audio/video signals to a local visual display device such as a television system (TV). In case of computer games the input devices of the computer the keyboard, the mouse etc are used to control the game and the monitor (a visual display device which lacks a tuner is properly called a monitor) or the TV screen becomes the video display output device. A television system may use different technical standards such as digital television (DTV) and high-definition television (HDTV). Computer devices such as Tablet computers and handheld devices such as big-screen phones have colorful graphics and crisp displays, ideal for gamers. Those devices are often used as a platform for audio and visual media such as books, periodicals, movies, music, and games, as well as web content.

Networks games allow multiple players whose computers are in a Local Area Network (LAN), to play a single game simultaneously and compete with each other. The sharing of a game console between multiple players in a LAN depends on the networking and communication of machines or devices, and optimizing traffic communication across networks interconnecting such machines and devices.

There is a need for providing, social network gaming, network gamers and online casino gambling gamers (for free or for real money where legal) with improved compatibility access while offering a wider games selection of computer games from videogame and console device makers such as Nintendo®'s Wii, Microsoft®'s X-Box, Sony®'s PlayStation etc., to be managed via the Master set-top box. An infrastructure is required which permits a gamer to request connection to a remote game console by using a computerized order entering system. If an access is available and is granted or authorized by the Master set-top box's owner the gamer is connected to that remote game console and plays games with other gamers who are also connected to that game console via the Master set-top box.

Several systems and methods have attempted to provide such network and sharing. U.S. Pat. No. 6,145,084 to Zuili, et al. discloses methods and apparatus enabling dissimilar devices to exchange information over a computer network stores a database of permissible sending and receiving devices at a verification server. A first device generates a request send authorization signal, which is compared at the server to the stored database and, in the event of a correspondence; a send authorization signal is generated by the server. Before a complete exchange may occur, however, a request receive authorization signal is generated at the second device in response to receiving the communication signal from the first device. The request receive authorization signal is compared to the database at the server and, in the event of a correspondence, a receive authorization signal is generated by the server, causing the second device to receive the message from the first device. A translation function is preferably provided prior to the step of causing the second device to receive the message from the first device, which may be related to dissimilar device hardware, software device protocol, network security, domestic/international communication standards, language or other factors, as appropriate.

U.S. Pat. No. 5,904,620 to Kujawa discloses an apparatus for networking computer games in a centrally located game storage accessed by remote game key pads, comprises a keypad interface for receiving game control data from the key pad, and means for connecting the keypad interface in parallel across a telephone pair for communicating the modulated data format to a switched telephone The game control data being frequency modulated with a center frequency, above the audible frequency range, to obtain a modulated data format.

Similarly U.S. Pat. No. 6,633,901 to Zuili discloses a flat network architecture facilitates direct connections between nodes so that information may be retrieved more efficiently. Agent software is loaded on each participating node that is sufficiently intelligent to share and relay information appropriately in accordance with user requests.

U.S. Patent Publication No 20080119290, discloses a remote console server that is configured to digitize an analog signal from the game console, wherein information sent across the Internet by using digital signals must be converted to digital signals.

The prior arts described above fail to describe recovery of High-Definition Multimedia Interface (HDMI) signals. The researchers and founders of the HDMI copy protection are Philips, Toshiba, Hitachi, Matsushita Electric Industrial, Silicon Image, Sony, Technicolor SA. High-bandwidth Digital Content Protection (HDCP) has been developed by Intel Corporation. HDCP prevents copying of digital audio and video content as it travels across DisplayPort, Digital Visual Interface (DVI), High-Definition Multimedia Interface (HDMI), Gigabit Video Interface (GVIF), or Unified Display Interface (UDI) connections. None of the prior arts recover an HDMI signal, dynamic HDCP keys, share the audio/video content among the peer without relying on a central server, and send back data received from the remote device to another device in order to control the audio/video content.

Therefore, the present scenario is necessitating the need for a new system and method capable of overcoming disadvantages inherent in the prior arts and providing an effective means to recover the HDMI signal, dynamic HDCP keys, share the audio/video content among the peer without relying on a central server, and send back data received from the remote device to another device in order to control the audio/video content.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent in the prior art.

In one aspect, the present invention generally provides system and method for networking and communication between devices in a network environment, and more particularly to system and methods for rendering content from a first device to a second device in a network environment.

In another aspect, the present invention provides a method for rendering content from a first device to a second device in a network environment. The method comprises the steps of: providing atleast a Master set-top box, sending an invitation and a corresponding HDCP code from the Master set-top box or the Remote set-top box to the Remote set-top box or the Master set-top box via a network interface, approving the invitation of the Remote set-top box and pairing the Master set-top box with atleast an available Remote set-top box, digitizing and compressing the content from the game console using the virtualization engine, splitting the compressed digital content into a plurality of network packets and sending the splitted network packets to the Remote set-top box via the network interface, decompressing the received plurality of network packets, and sending the decompressed network packets to an audio/video output device. The network interface includes atleast any one of the Internet, LAN, WAN, Wi-Fi, Ethernet network using wired or wireless communication means or any combination thereof.

In another aspect, the present invention provides a system for rendering content from a game console with a set-top box to a device with a set-top box in a network of a plurality of devices, such that each set-top box share a distributed hash table and assign key-value pairs with other set-top boxes. The system comprises: atleast a Master set-top box including a virtualization engine configured to allow access to the game console to be managed via the Master set-top box; a plurality of Remote set-top boxes configured to communicate with the game console and to allow the game console to receive game control signals from the plurality of devices; an audio/video output unit associated with the game console; a plurality of audio/video output units corresponding to the plurality of devices; a plurality of game control units corresponding to the plurality of devices; atleast a signal compression means in the virtualization engine for digitizing compressing the content from the game console; atleast a decompressing means to decompress the received compressed content; and means to send the content to an audio/video output device.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

For a better understanding of the nature of the present invention, reference should be made in the detailed description taken in conjunction with the accompanying drawings in which:

FIG. 1 shows a game console available in the prior art;

FIG. 2 is a schematic diagram of the connection between a Master set-top box and a Remote set-top box, according to an exemplary embodiment of the present invention;

FIG. 3 is a schematic diagram showing connection between the Master set-top box and two Remote set-top boxes, according to an exemplary embodiment of the present invention;

FIG. 4 is a schematic diagram of the Master set-top box, according to an exemplary embodiment of the present invention;

FIG. 5 is schematic view of a network of set-top boxes, according to an exemplary embodiment of the present invention;

FIG. 6 is a schematic view of the system for rendering content from one device to another device, according to an exemplary embodiment of the present invention;

FIG. 7 is a schematic diagram of the components of the Master set-top box, according to an exemplary embodiment of the present invention;

FIG. 8 is a flowchart of the method for rendering content from one device to another device, according to an exemplary embodiment of the present invention; and

FIG. 9 is a flowchart of the method for rendering content from one device to another device, according an exemplary embodiment of the present invention.

Like reference numerals refer to like parts throughout the several views of the drawings.

### DETAILED DESCRIPTION OF THE INVENTION

The exemplary embodiments described herein detail for illustrative purposes are subject to many variations and structure and design. It should be emphasized, however that the present invention is not limited to a particular system and methods for rendering content from a first device to a second device in a network environment as shown and described. Rather, the principles of the present invention may be used with a variety of content rendering configurations and structural arrangements. It is understood that various omissions, substitutions of equivalents are contemplated as circumstances may suggest or render expedient, but the present invention is intended to cover the application or implementation without departing from the spirit or scope of the claims.

In the following detail description, for purposes of explanation, numerous specific details are set forth in order to provide a thorough understanding of the present invention. It will be apparent, however, to one skilled in the art that the present invention may be practiced without these specific details.

As used herein, the terms ‘a’, ‘an’, ‘atleast’ do not denote a limitation of quantity, but rather denote the presence of at least one of the referenced item, the term ‘a plurality’ denotes the presence of more than one referenced items.

In an exemplary embodiment, the present invention provides improved systems and methods for rendering content from a first device to a second device in a network environment. The systems of the present invention may be mass produced inexpensively and provides user an easy, efficient, secure, cost effective, and environment friendly way for rendering content from the first device to the second device in a network environment.

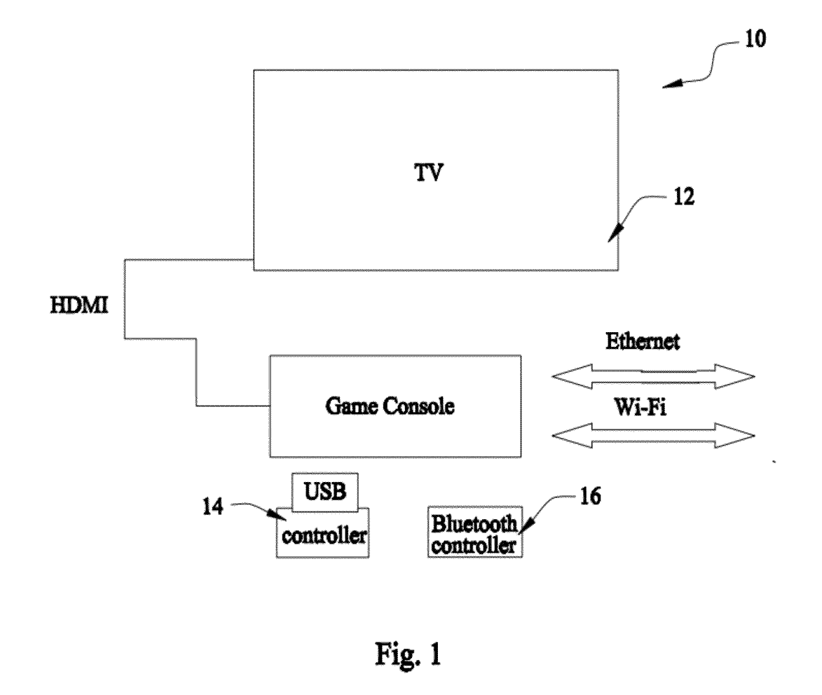

Referring to FIG. 1 which shows a game console 10 available in prior art. The game console 10 is connected to an audio/video output device such as a television 12, by using HDMI. The game console 10 has the capability to connect to a Wi-Fi or Ethernet network using wired or wireless communication means. The game console 10 also includes a USB controller 14 to transfer data from a computer to the game console. A Bluetooth controller 16 is also provided with the game console to interact with neighboring Bluetooth devices.

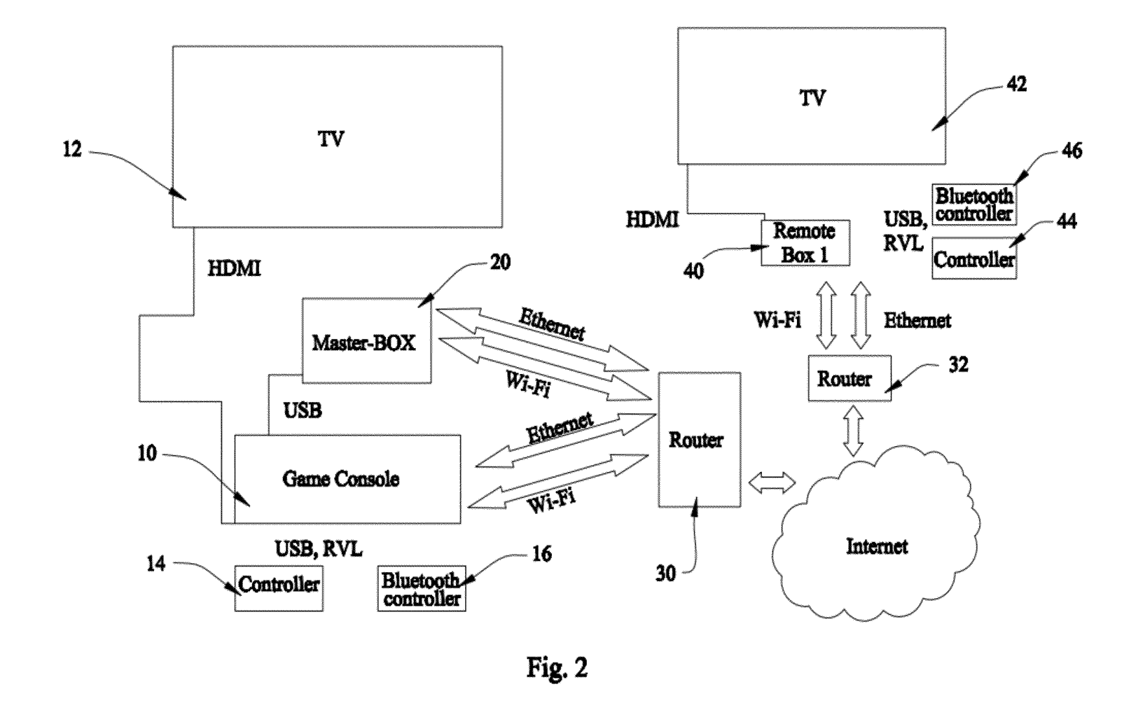

Referring to FIG. 2 which is a schematic diagram of the connection between a Master set-top box and a Remote set-top box, according to an exemplary embodiment of the present invention. The game console 10 is also connected to a Master set-top box 20 by means of a USB connection. The Master set-top box 20 is connected to the Internet using a router 30, which means that the Master set-top box 20 may acts as a connection between a game console 10 and a remote device by means of Internet.

The Remote set-top box 40 has its own TV 42 and USB/RVL controller 44 and a Bluetooth controller 46. The Remote set-top box 40 also connects to the Internet by using a router 32. In order to play a game from a Remote location far from the game console 10, the Remote set-top box 40 sends a request to the Master set-top box 20 via Internet to allow it to be paired. Each set-top box including the Master set-top box 20 as well as the Remote set-top box 40, share a distributed hash table and assign key-value pairs with other set-top box devices such that each set-top box are paired with atleast a device.

In an exemplary embodiment of the present invention the Master set-top box 20 may be connected to an audio/video source signal, game box, set-top box, IP set-top box, DVD, Blue-ray, 3D DVD players, thru HDMI, DVI, RGB, PERITEL connection. Master set-top box 20 may also be connected directly or by wireless, including infrared, and radio, to atleast any one of a game box, a DVD, a controller, a remote controller or any combination thereof. Remote set-top box 40 may be connected to a screen, and one or multiple controllers may be attached to the Remote set-top box 40 in order to send back the controllers data received to the Master set-top box 20 using other devices in the network.

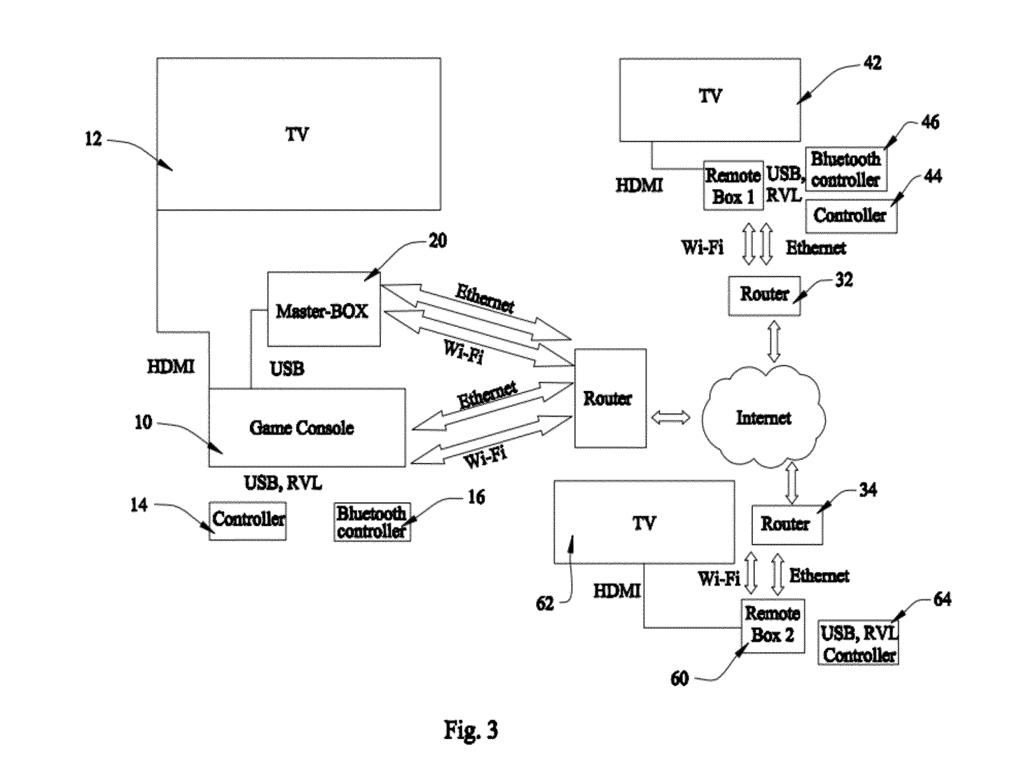

Referring to FIG. 3, which illustrates a network of two Remote set-top boxes 40 and 60 with a Master set-top box 20, according to an exemplary embodiment of the present invention. The network contains a Remote set-top box 60 in addition to Master set-top box 20 and Remote set-top box 40 as shown in FIG. 2. The Remote set-top box 60 is also equipped with TV 62, and USB/RVL controller 64. The Remote set-top box 60 also communicates with Master set-top box 20 and Remote set-top box 40 via Internet using a router 34.

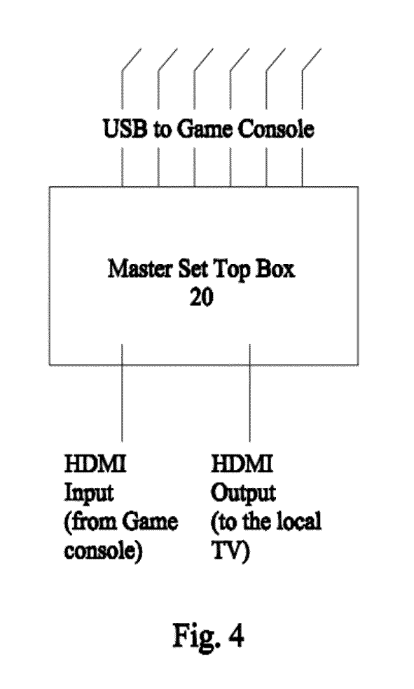

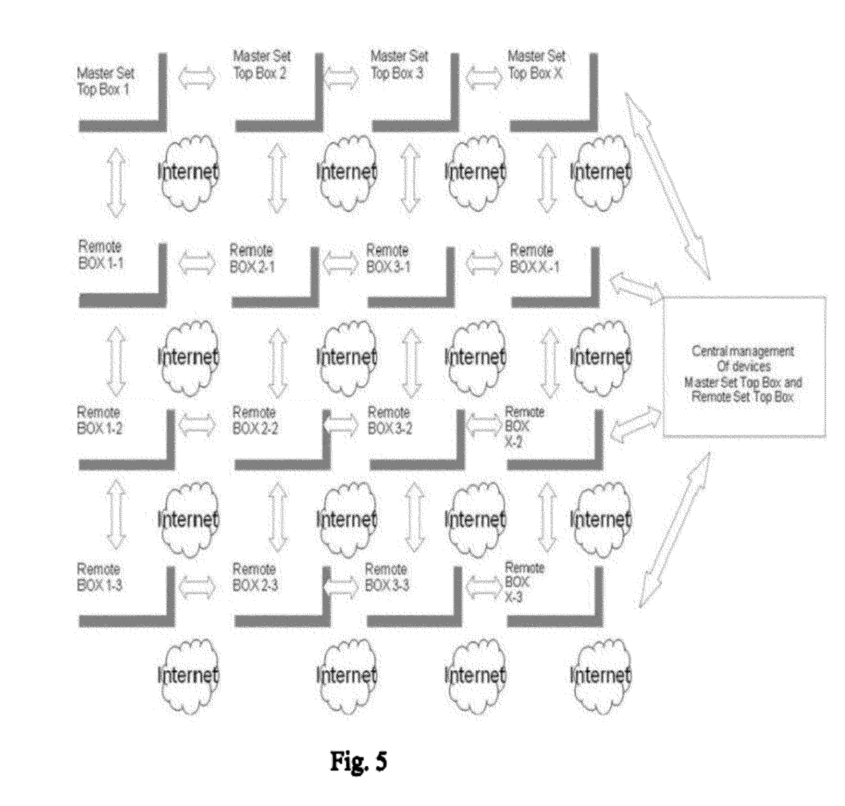

Referring to FIG. 4 which is a schematic diagram of the Master set-top box 20, according to an exemplary embodiment of the present invention. The Master set-top box 20 comprises at least one HDMI input and a HDMI output. The HDMI input is used to get content from the game console 10 (as shown in FIGS. 2 and 3) and the HDMI output is used to display the content on a display device such as a TV (12 or 42 shown in FIGS. 2 and 3). The Master set-top box 20 also includes USB ports to establish connection with the game console 10 via USB interfaces.

Referring to FIG. 5 which is a schematic view of a network of set-top boxes, according to an exemplary embodiment of the present invention. A plurality of Master set-top boxes and Remote set-top boxes are connected to each other by the Internet. There are two networks first a Master set-top box network and second a Remote set-top box network. Each of these networks may have atleast a hash table that cannot have more than 2 m nodes using a consistent integral hashing and where both keys and ID (IP addresses) are uniformly distributed. Each node may have a successor and a predecessor based on the geographical location of each IP address. Each node orders on the geo location and autosense speed of the network may be organized. If a node leaves the network, the next node will then takeover.

Remote set-top boxes 40 and 60 are paired with Master set-top box 20. Remote set-top boxes 40, 60 send an invitation to Master set-top box 20, and upon approval on the Master set-top box 20, pairing will occur. By storing a hash representing the pairing value, a Remote box may be paired with an unlimited number of Master set-top boxes. The Master set-top box 20 may be paired with a fix number of players depending on the game station capabilities. Invitations may be triggered using social gaming network, cloud computing (also referred to as ‘servers’ more specifically the term “cloud” is used as a reference for the Internet), or any designated domain. Typical cloud computing providers deliver business applications that are accessed from a software such as a Web browser, while the software and data are stored on servers. Distributed Cloud gaming is a byproduct of cloud computing, where media distribution and interactivity are securely shared among owners of a game and the other players (other players also referred to as “piggy-back players”, “outside players” or “authorized guest players” are enjoying on a temporarily basis a game whose ownership belongs to another exactly like a “Monopoly®” player who is not the owner of that game) interact transparently and where servers coexist with client-servers, owners, players. Cloud computing infrastructures consist of services delivered through common centers and built on servers. In the context of our application the term “cloud computing” has become something of a misnomer, possibly helping the adoption of the term “Distributed Cloud Gaming” or ‘“DCG”’. A distributed cloud gaming method where interactive resources are securely shared among multiple users and networks. List of denied Remote set-top boxes, Master set-top box (blocked) is managed by each network. One blocked list for the Master set-top box, one blocked list for the Remote set-top box. Each Master and Remote set-top box have a dynamic HDCP code, downloaded from a cloud computing pre-designated domain, at first but when the HDCP code is stored on at least one Master set-top box and at least one Remote set-top box, then it replicate by itself onto each nodes/networks immediately.

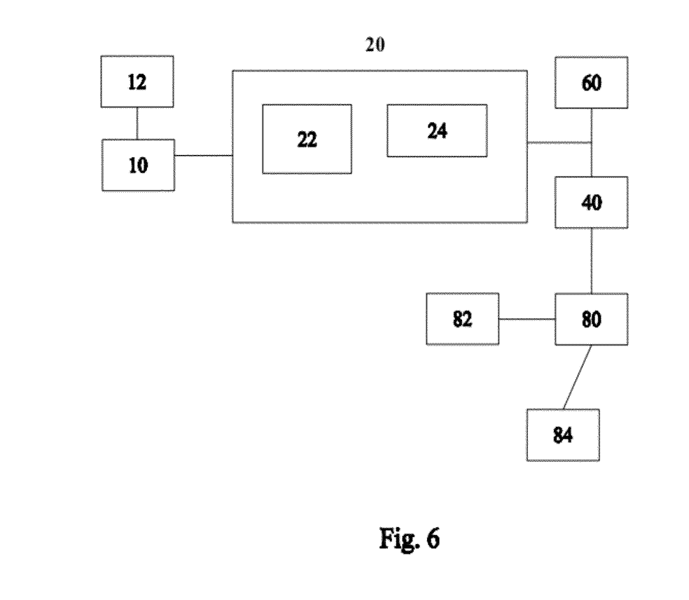

Referring to FIG. 6 which is a schematic view of the system 100 for rendering content from one device to another device, according to an exemplary embodiment of the present invention. The system 100 for rendering a content from a game console 10 with a set-top box to a device 80 with a set-top box such as Remote set-top box 40 in a network of a plurality of devices, such that each set-top box share a distributed hash table and assign key-value pairs with other set-top boxes. The system 100 according to the present invention comprises a Master set-top box 20 including a virtualization engine 22 configured to allow access to the game console 10 to be managed via the Master set-top box 20, a plurality of Remote set-top boxes 40, 60 configured to communicate with the game console 10 and to allow the game console 10 to receive game control signals from the plurality of devices. For example, the device 80 is one of the devices in a network of plurality of devices and is associated with the Remote set-top box 40. The system 100 further comprises an audio/video output unit such as TV 12 associated with the game console 10, an audio/video output unit 82 corresponding to the device 80, a game control unit 84 corresponding to the device 80, a signal compression means 24 in the virtualization engine 22 for digitizing compressing the content from the game console 10, a decompressing means 26 to decompress the received compressed content, and means to send the content to an audio/video output device 86 associated to the device 80.

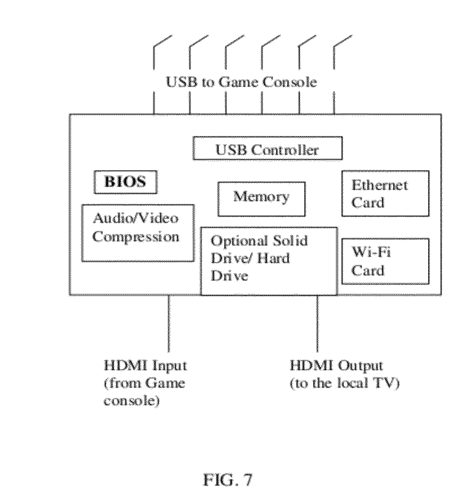

Referring to FIG. 7 which is a schematic diagram of the components of the Master set-top box 20, according to an exemplary embodiment of the present invention. The Master set-top box 20 comprises the virtualization engine 22 which includes the signal compression means 24, a memory to store the signals, a USB controller, a Ethernet/Wi-Fi card to connect to the router, a HDMI input to receive the multimedia signals from the game console, and a HDMI output to transmit the video signals to the local display device. The Master set-top box 20 further includes an emulation unit for storing a game configuration from the game console 10 using a memory card emulation unit built-in within the Master set-top box 20 and restores the game configuration to the game console 10 using the memory card emulation unit.

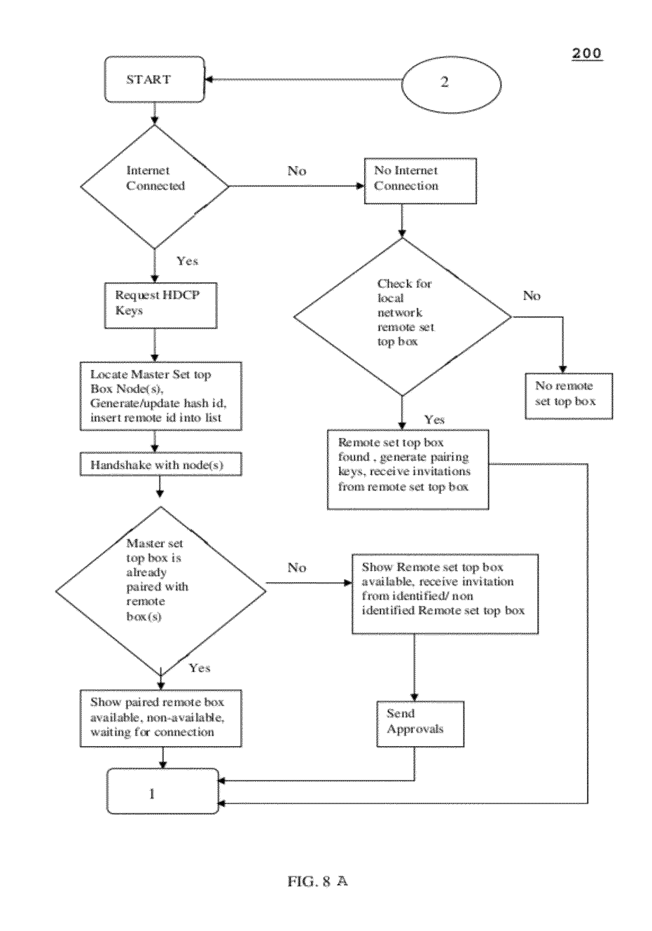

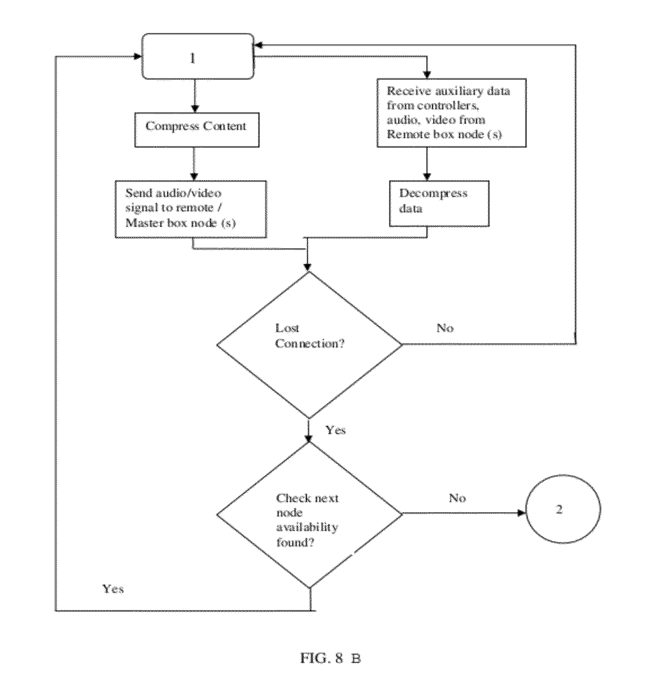

Referring to FIGS. 8A and 8B which shows a flowchart of a method 200 for rendering content from one device to another device, according to an exemplary embodiment of the present invention. The method 200 starts and the first step is checking whether the Internet is connected or not? If the Internet is found to be connected it will precede to next step of request the HDCP keys from the set-top boxes environment network. It will locate the Master set-top box 20 and will generate the hash keys associated with all devices in the network hereafter also referred as nodes. Once the HDCP keys and hash keys are matched the Master set-top box 20 and Remote set-top boxes 40, 60 handshake that means they are paired and connected to each other directly, but also with other set-top boxes that acts as relays using an environment network such as the Internet. When the Master set-top box 20 is paired with Remote set-top boxes 40, 60, it may shows the status of the connection between the Master set-top box 20 and Remote set-top boxes 40, 60 as available, non available or waiting for connection.

If the pairing has not happened then the Master set-top box 20 may shows the Remote set-top boxes 40, 60, as available for pairing and receives invitation to pair from an identified Remote set-top box. If the Master set-top box 20 approves the pairing then both are paired with each other and are ready to exchange data.

The data is then compressed by using the signal compression means and the audio/video signal is sent to Master set-top box 20 or Remote set-top boxes 40, 60. In the same step an auxiliary data which includes game controls and audio/video signal is decompressed and then forwarded to the desired device in a network of plurality of devices. In next step the connectivity is checked and if the connection is lost then available of next node is checked.

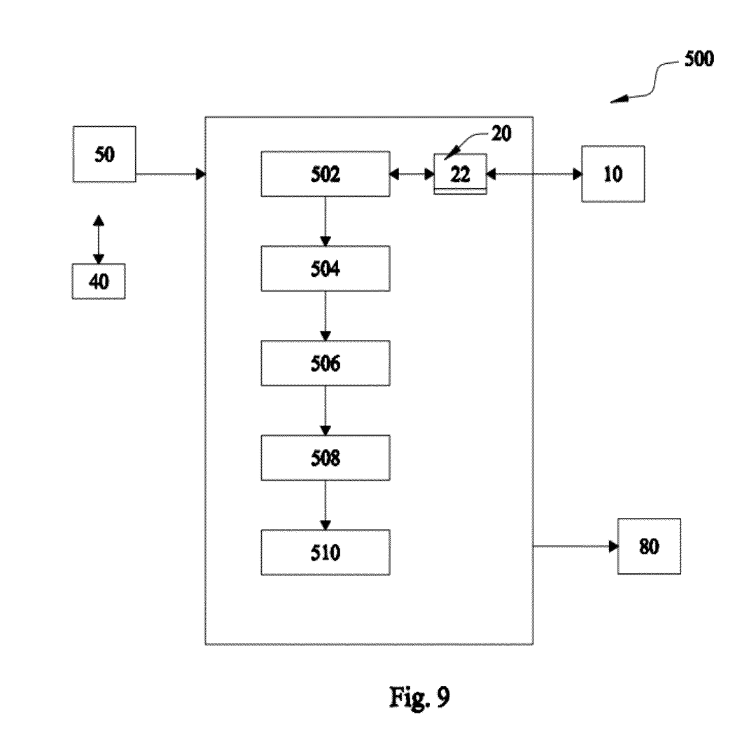

Referring to FIG. 9 which is a flowchart of the method 500 for rendering content from one device to another device, according to another exemplary embodiment of the present invention.

The method 500 for rendering content from a first device 50 to atleast a second device 80 in a network environment, starts with a step 502 of providing the Master set-top box 20 including a virtualization engine 22 configured to allow access to the game console 10 to be managed via the Master set-top box 20 and to allow the Remote set-top box 40 to communicate with the game console 10. Also to allow the game console 10 to receive game control signals from the plurality of devices.

At step 504 an invitation and a corresponding HDCP code from the Remote set-top box 40 is sent to the Master set-top box 20 via a network interface including Internet, LAN. In next step 506 the invitation of the Remote set-top box 40 is approved by the Master set-top box 20 and a pairing is established with available Remote set-top boxes.

Step 506 is digitizing and compressing the content from the game console 10 using the virtualization engine 22. In next step 508 the compressed digital content is split into a plurality of network packets and where the network packets are sent to the Remote set-top box 40 via a network interface including Internet, LAN. Step 510 is decompressing the received plurality of network packets, and sending them to an audio/video output device. The first device 50 includes atleast a game console which is coupled with a first set-top box, wherein the second device 80 is coupled with a second set-top box, such that the first set-top box and the second set-top box share a distributed hash table and assign key-value pairs with other set-top boxes.

Peer is at least one device which is a part of a network of plurality of devices used in the present invention and hereafter will carry the same meaning. In an exemplary embodiment of the present invention, the method 500 may share the peer to peer audio/video-data that is shared among the Master set-top box 20 and sent to an appropriate Remote set-top box 40 depending on the network speed and bandwidth of each device. It may also send an HDMI signal (audio/video) remotely where the Remote set-top boxes 40, 60 recovers a dynamic HDCP key in order to remotely view the audio/video signal, as well as sending back controls received from game controller to the Master set-top box 20.

In the method 500, a protected HDMI signals may be shared among peer devices, by assigning a HDCP key to the Remote set-top boxes 40, 60 and Master set-top box 20 and having the possibility for the user of receiving interactive advertising during for instance a pause initiated by an user on the Remote session. Preference during the implementation is to maximize the speed of content rendering among peers, in between different networks, as well as providing ‘real-time’ sensations to gamers, using the hash key in between peers to minimize the network latency, and ‘autosense’ the network capabilities of each peers during each sessions at specified time intervals.

In another exemplary embodiment of the present invention, the controllers may include any game controllers from all manufacturers, including an emulation of the game box, for the feedback data like vibrations, ‘motion’ sensors, and Remote controls capabilities.

In another exemplary embodiment of the present invention, the method 500 may be used for fragmenting an video-audio file pertaining to a set-top box, to be distributed to one or more devices in a network, where each set-top box share a distributed hash table and assign key-value pairs with other set-top boxes, and where each set-top box is paired with one or more devices. The method comprises the steps of dividing the file into a sequence of data blocks, wherein the sequence of data blocks being partitioned into a first portion and a second portion, such that each of the data block includes at least several Kbytes, the forming a header from the data blocks in the first portion, the data blocks in the header being consecutive, a data size of the header being predetermined to ensure that a playback of the title proceeds without jitters. Next step is forming N segments, each of the N segments including some of the data blocks in the second portion, the data blocks in each of the N segments being nonconsecutive, wherein N is a finite integer; such that (i) at least one of the devices coupled to a network is configured to download data at a rate D, and uploading auxiliary data to a paired set-top box and (ii) a downloading on the at least one device is affected by one or more interruptions that cause the first device to not receive any data for a period of time X; and wherein the data size of the header is dynamically defined to account for possible abnormal conditions in the network, the data size being at least:

D*X+Max(over all times t>=X)[byte offset for corresponding frame−D*t]

and where each set-top box and devices receive HDCP codes and advertising from predetermined cloud computing providers.

In another exemplary embodiment of the present invention, the distributed file is a collection of audio/video data together including optionally switched polarity data for 3D vision and where uploaded auxiliary data is a collection of audio/video and data representing controllers data. The set-top box is directly connected to an audio/video source.

In another exemplary embodiment the devices may be software installed on computers and where input controllers may be directly connected to such computer.

In another exemplary embodiment of the present invention, the header is locally cached in each of the one or more set-top boxes as a residing object, and M of the N segments are distributed as distributed objects to each of the one or more paired devices, wherein M varies between 0 and N from one of the devices to another. The data size of the header is determined such that when the title is played back, the header lasts just long enough to start receiving the M segments from one or more of the set-top box. The data size of the header may be extended to include some extra time for synchronizing the M segments being respectively fetched from the one or more of the set-top boxes. The data size of the header may be determined to last a certain period, such that, when the certain period ends, some data from the M segments being fetched from one or more of the set-top box has already arrived.

In another exemplary embodiment of the present invention, the data size of the header is statistically determined in a region to have enough data to account for irregularities in downloading the M segments from one or more of the set-top boxes. The header may include at least three sections of data, each section specifically provided to deal with a particular irregularity. The three sections may include an audio/video data buffer, a downstream jitter buffer, and an upstream jitter buffer, where the audio/video data buffer is defined to last X seconds, the downstream jitter buffer is defined to last Y seconds, and the upstream jitter buffer is defined to last Z seconds, and wherein the audio/video data buffer is enough before some data from the M segments becomes available to succeed the header, Y is statistically determined to ensure that there are enough data to overcome possible jitters in downloading, and Z is statistically determined to ensure that there are enough data to overcome possible jitters due to a sudden loss of the required uploading bandwidth.

In another exemplary embodiment of the present invention, the data size of the header may be dynamically determined with respect to audio/video file and a respective one of the devices in which the header is to be cached. The header may include at least an audio/video data buffer, a downstream jitter buffer, and an upstream jitter buffer, the audio/video data buffer includes enough data to supplement a playback when an actual bitrate (Allowed bitrates for the transported data depend on speed and number of encoding and modulation parameters) is higher than an average bitrate, the downstream jitter buffer and the upstream jitter buffer include additional data that supplement the average bitrate when an already allocated bandwidth for downloading or uploading becomes narrower.

In another exemplary embodiment of the present invention, a FIFO data buffer is provided and fed with the header first followed by received data from the M segments being continuously retrieved from the one or more of the set-top boxes and paired devices together with data from N-M locally cached segments. When the video-audio file, data from the M segments being continuously retrieved from one or more of the set-top boxes and paired devices together, the N-M segments are multiplexed into the FIFO data buffer. The multiplexed data in the data buffer is part of the second portion of the data blocks.

In another exemplary embodiment of the present invention, when signal of the multimedia digital content is rendered, data from L of the M distributed objects being continuously retrieved from one or more of the set-top boxes and paired devices together with data from the N-M segments are multiplexed into a data buffer.

In another exemplary embodiment of the present invention, one of the L distributed objects pertains to audio data in a preferred language, and the one of the L segments and the N-L segments are sufficient to render the audio/video digital content signal and uploading of the auxiliary data.

In another exemplary embodiment of the present invention, forming N segments may comprise concurrently decimating the second portion of the data blocks into the N segments.

In an exemplary embodiment of the present invention, the method may have lower design rules, fast-access two-level cache, a DMA (Direct Memory Access) circuit and a wider bus system. The DMA allows for hardware in a computer to access system memory independently of the system processor. The processor is not involved in the transfer of data, because DMA is fast, DMA is used for example in real-time applications and for making backups as well.

In an exemplary embodiment of the present invention, the system may consist ARM Cortex-A8 which has a 128-bit wide SIMD unit that can have impressive 16- and 8-bit performance for industry standard benchmarks. High performance processing power is required. OMAP3 processors include a Cortex-A8 and C6000 DSP which allows software designers to implement signal processing code with the dedicated DSP or with Cortex-A8 NEON SIMD extensions. Set-top box is capable of connecting to standard-definition (SD), enhanced-definition, and high-definition (HD) televisions. The set-top box connects to a television by HDMI, component, S-Video, or composite video cables. Audio is provided through HDMI, digital coax, digital optical ports, or stereo analog. The Master set-top box or/and the Remote set-top box connect to the Internet through an Ethernet port with the provided Ethernet cable. Wireless is supported with security encryption such as the WEP security encryption. HDMI (High-Definition Multimedia Interface) is a compact audio/video interface for transmitting uncompressed digital data. HDMI connects digital audio/video sources—such as set-top boxes, up convert DVD players, HD DVD players, Blu-ray® Disc players, AVCHD camcorders, personal computers (PCs), and video game consoles such as the PlayStation 3 and Xbox 360, and AV receivers—to compatible digital audio devices, computer monitors, and digital televisions. There may be four HDMI connector types. Type A and Type B are defined in the HDMI 1.0 specification, Type C is defined in the HDMI 1.3 specification, and Type D is defined in the HDMI 1.4 specification. HDMI also supports any IEC 61937-compliant compressed audio stream, such as Dolby Digital and DTS, and up to 8 channels of one-bit DSD audio (used on Super Audio CDs) at rates up to four times that of Super Audio CD.[45] With version 1.3, HDMI supports lossless compressed audio streams Dolby TrueHD and DTS-HD Master Audio.

There is at least one USB port present on the Master set-top Box 20. The Master set-top box 20 is designed to exist separately from both a computer and cable/satellite television system. A user must only provide a broadband Internet connection to use the service. Users can access to others Master set-top box 20 via Remote set-top boxes 40, 60 or through a server. For example, a company's website may also be connected to the server. The company's website or any affiliated websites will be displaying the list of Master set-top boxes, the list of Remote set-top boxes and the network of the devices which are available to self-registered users anywhere in the world in order for those self-registered users with a broadband connection to be able to find and to access a particular game regardless of the type of the game console brand.

In another exemplary embodiment of the present invention, the system may comprise interactive media devices which are used to distribute full-length movies to any television, using a hybrid peer-to-peer TV technology. Demodulation (such for instance a QAM demodulator) is an act of extracting the original information-bearing signal from a modulated carrier wave. A demodulator is an electronic circuit used to recover the information content from the modulated carrier wave. Another common one is in a modem, which is a contraction of the terms modulator/demodulator. Integrated receiver/decoder IRDs has the distinct feature of outputting uncompressed SDI signals. Professional set-top boxes are referred to as IRDs or integrated receiver/decoders in the professional broadcast audio/video industry. IRDs have the distinct feature of outputting uncompressed SDI signals, unlike consumer set-top boxes which don't mostly because of copyright reasons.

In another exemplary embodiment of the present invention, Hybrid IPTV Set-Top Boxes also enable consumers to access a range of advanced interactive services, such as VOD and time-shifting TV, as well as internet applications, including video telephony, surveillance, gaming, shopping, e-government accessed via a television set.

In case of IPTV networks, the set-top box is a small computer providing two-way communications on an IP network and decoding the video streaming media. IP set-top boxes have a built in home network interface which can be Ethernet or one of the existing wire home networking technologies such as HomeDNA or the ITU-T G.hn standard, which provides a way to create a high-speed (up to 1 Gigabit/s) Local area network using existing home wiring (power lines, phone lines, and coaxial cables).

In another exemplary embodiment of the present invention, IPTV (often on ADSL or optical fiber networks) and set top boxes may be adapted to allow the consumer to have access to IPTV, VoIP, Internet, and media center functionalities.

Set-top boxes are often placed beneath televisions, and the term set-top box has become something of a misnomer, possibly helping the adoption of the term digital-box or ‘digibox’.

A set-top box does not necessarily contain a tuner of its own. A box connected to a television (or VCR) set's SCART connector is fed with the baseband television signal from the set's tuner, and can ask the television to display the returned processed signal instead.

In another exemplary embodiment of the present invention, 3 or 4G network connections may be added to the next-generation of handheld game machines, potentially opening the door to new forms of connected game play and adding to the growing number of devices that are able to access high-speed telecommunication networks. Videogame makers know that, for portable game machines to take the next step forward, they need wireless communication.

In another exemplary embodiment of the present invention, 3. or 4G wireless network connections may be capable to allow users to access Web-based content or services even in places without a Wi-Fi connection.

In another exemplary embodiment, the present invention is capable of allowing the device to automatically link to other 3DS machines or access the Internet even when it is not in use. Further, the device may shares characteristics of handheld game machines, e-book readers, iPad, Palm Pad, and notebook computers.

In another exemplary embodiment, the present invention may play videogames in 3D without the need for special glasses.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state ‘means for’ performing a specified function, or ‘step for’ performing a specific function, is not to be interpreted as a ‘means’ or ‘step’ clause as specified in 35 U.S.C. §112, paragraph 6. In particular, the use of ‘step of’ in the claims herein is not intended to invoke the provisions of 35 U.S.C. §112, paragraph 6.

Although exemplary embodiments of the present invention have been shown and described, various modifications and substitutions may be made thereto without departing from the spirit and scope of the invention. Accordingly, it is to be understood that the present invention has been described by way of illustration and not limitation.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method for rendering atleast a content from atleast a first device to atleast a second device in a network environment, the method comprising the steps of:
providing a Master set-top box including a virtualization engine;
sending an invitation and a corresponding HDCP code from the Remote set-top box to the Master set-top box via a network interface;
approving the invitation of the Remote set-top box and pairing the Master set-top box with available Remote set-top boxes;
digitizing and compressing the content from the game console using the virtualization engine;
splitting the compressed digital content into a plurality of network packets and sending the splitted network packets to the Remote set-top box via the network interface; and
decompressing the received plurality of network packets and sending the decompressed network packets to atleast an audio/video output device,
wherein the first device includes atleast a game console which is coupled with a first set-top box, wherein the second device is coupled with a second set-top box, wherein the first set-top box and the second set-top box share a distributed hash table and assign key-value pairs with other set-top boxes.

2. The method according to claim 1, wherein the content includes atleast any one of an audio data, video data, a polarity data for 3D vision, a data representing the Remote set-top box or any combination thereof.

3. The method according to claim 1, further comprising the steps of:
receiving a game controller signal from the first device; and
sending the game controller signal to the second Remote set-top box via a network interface.

4. The method according to claim 1, further comprising the steps of:
storing a game configuration from the game console using a memory card emulation unit within the Master set-top box; and
restoring the game configuration to the game console using the memory card emulation unit.

5. The method according to claim 1, further comprising the steps of:
saving a game configuration from the Remote set-top box server to a server; and
restoring the game configuration to the Master set-top box from the server.

6. The method according to claim 5, wherein the server is configured to manage access to a plurality of game consoles by a plurality of Remote set-top boxes through the Master set-top box using the virtualization engines, wherein the server is capable of communicating with the Remote set-top boxes to allow the Remote set-top boxes to locate the Master set-top box and the associated game console.

7. The method according to claim 1, wherein the virtualization engine is configured to perform atleast any one of communicating with multiple game controller inputs for the first device to allow multi-controller multiplayer game play on the first device, allowing access to the game console to be managed via the Master set-top box, allowing a Remote set-top box to communicate with the game console, allowing the game console to receive game control signals from the plurality of devices or any combination thereof.

8. The method according to claim 1, wherein atleast any one of the Remote set-top box and the Master set-top box is directly connected to atleast any one of an audio source, a video source or any combination thereof.

9. The method according to claim 1, wherein atleast any one of the Master set-top box and the Remote set-top box includes atleast any one from a group including a hardware, a software, a firmware or any combination thereof.

10. The method according to claim 9, wherein the Master set-top box and the Remote set-top box is a software stored on atleast any one from a group including a separate machine, a server, the game console, a storing device, Internet or any combination thereof.

11. A system for rendering content from a game console with a set-top box to a device with a set-top box in a network of a plurality of devices, the system comprising:
atleast a Master set-top box including a virtualization engine configured to allow access to the game console to be managed via the Master set-top box;
a plurality of Remote set-top boxes configured to communicate with the game console and to allow the game console to receive game control signals from the plurality of devices;
an audio/video output unit associated with the game console;
a plurality of audio/video output units corresponding to the plurality of devices;
a plurality of game control units corresponding to the plurality of devices;
a signal compression means in the virtualization engine for digitizing and compressing the content from the game console;
decompressing means to decompress the received compressed content; and
means to send the content to an audio/video output device,
wherein each set-top box share a distributed hash table and assign key-value pairs with other set-top boxes.

12. The system according to claim 11, wherein a server is a cloud computing system which is communicably connected with atleast any one of the Master set-top box, the Remote set-top box, and the virtualization engine are part of the server alone or in any combination thereof, wherein server is capable of centrally manage the Master set-top box, Remote set-top box and the network of the devices.

13. The system according to claim 11, wherein the virtualization engine is configured to digitize, compresses, split and transmits the content via a network interface including Internet, LAN.

14. The system according to claim 11, wherein the Master set-top box comprises the virtualization engine, wherein the virtualization engine includes atleast any one of a signal compression means, a memory to store the signals, a USB controller, a Ethernet/Wi-Fi card to connect to a router, a HDMI input to receive the multimedia signals from the game console, a HDMI output to transmit the video signals to the local display device or any combination thereof.

15. The system according to claim 11, wherein the Remote set-top box comprises atleast any one of a signal compression means, a memory to store the signals, a USB controller, an Ethernet, a Wi-Fi card to connect to the router, a HDMI input to receive the multimedia signals from the game console Master set-top box relayed by group relays, a HDMI output to transmit the video signals to the local audio/video output device or any combination thereof.

16. A method for rendering atleast a content from atleast a first device to atleast a second device in a network environment, the method comprising the steps of:
sending an invitation and a corresponding HDCP code from the first device to a second device via a network interface;
approving the invitation of the first device;
pairing the first device with atleast an available second device;
digitizing and compressing contents from a game console using the virtualization engine;
splitting the compressed digital contents into a plurality of network packets;
sending the splitted network packets to the Remote set-top box via the network interface;
decompressing the received plurality of network packets; and
sending the decompressed network packets to atleast an audio/video output device,
wherein the first device includes atleast any one of a first Master set-top box, a first Remote set-top box or any combination thereof, wherein the second device includes atleast any one of a second Master set-top box, a second Remote set-top box or any combination thereof.
